(19) United States
(12) Patent Application Publication
(10) Pub. No.: US 2012/0072533 A1
(43) Pub. Date: Mar. 22, 2012

(54) DYNAMIC SERVICE GENERATION IN AN AGRICULTURAL SERVICE ARCHITECTURE

(75) Inventor: Christopher Burton O'Neil, Wichita, KS (US)

(73) Assignee: AGCO CORPORATION, Duluth, GA (US)

(21) Appl. No.: 13/236,902

(22) Filed: Sep. 20, 2011

Related U.S. Application Data
(60) Provisional application No. 61/384,518, filed on Sep. 20, 2010.

(51) Int. Cl. G06F 15/16; G06F 15/173

(52) U.S. Cl. 709/217; 709/224

(57) ABSTRACT

Dynamic service generation may be provided. An application service may be created. Upon receiving a data transmission from a machine, wherein the data transmission comprises a machine identifier, an application service may be identified as being associated with the machine according to the machine identifier. The application service may be invoked on the transmitted data and a response message may be received from the application service.

### RELATED APPLICATIONS

Under provisions of 35 U.S.C. §119(e), the Applicants claim the benefit of U.S. provisional application No. 61/384,518, filed Sep. 20, 2010, which is incorporated herein by reference.

Related U.S. patent application Ser. No. 12/915,803, filed on Oct. 29, 2010, and entitled “Agricultural Inventory and Invoice System,” assigned to the assignee of the present application, is hereby incorporated by reference.

Related U.S. patent application Ser. No. 12/915,792, filed on Oct. 29, 2010, and entitled “Dynamically Triggered Application Configuration,” assigned to the assignee of the present application, is hereby incorporated by reference.

Related U.S. patent application Ser. No. 12/915,777, filed on Oct. 29, 2010, and entitled “Trigger-Based Application Control,” assigned to the assignee of the present application, is hereby incorporated by reference.

Related U.S. patent application Ser. No. ______, filed on even date herewith and entitled “Allocating Application Servers in a Service Delivery Platform,” assigned to the assignee of the present application, is hereby incorporated by reference.

Related U.S. patent application Ser. No. ______, filed on even date herewith and entitled “Evaluating Triggers for Application Control and Machine Configuration,” assigned to the assignee of the present application, is hereby incorporated by reference.

Related U.S. patent application Ser. No. ______, filed on even date herewith and entitled “Billing Management System for Agricultural Services Access,” assigned to the assignee of the present application, is hereby incorporated by reference.

Related U.S. patent application Ser. No. ______, filed on even date herewith and entitled “Self-Provisioning by a Machine Owner,” assigned to the assignee of the present application, is hereby incorporated by reference.

### BACKGROUND

Dynamic service generation may be provided. In conventional systems, the automated ability for agricultural field owners or managers to coordinate complex interactions between diverse data analysis applications is not possible. Instead, equipment operators must manually instruct a system to capture such information, configure the equipment to gather the information correctly, remove the captured information from the machine, and transport the information to other systems for reports and/or invoices. This often causes problems because the equipment operators require specialized training for each type of work implement for which such information needs to be captured. For example, a fertilizer implement requires different information to be captured (e.g., areas covered, areas that may need additional attention, quantity of fertilizer used, etc.) than a harvesting implement (e.g., source location and quantity of the harvested material, pickup locations for remaining material, etc.). Furthermore, the manual configuration and delivery comprises an inefficient use of the equipment operators' time.

Precision Farming (PA), Farm Management Information Systems (FMIS), and Fleet Management Systems (FMS) comprise known examples of agricultural technology domain areas (ATDA) in the agricultural industry using an Agricultural Service Architecture to capture process data from farming machines operating on and off field. However, only the process data availability is addressed and a need for mechanisms of how to automatically invoke services and how to manage a flexible billing system exists.

### SUMMARY

Dynamic service generation may be provided. An application service may be created. Upon receiving a data transmission from a machine, wherein the data transmission comprises a machine identifier, an application service may be identified as being associated with the machine according to the machine identifier. The application service may be invoked on the transmitted data and a response message may be received from the application service.

It is to be understood that both the foregoing general description and the following detailed description are examples and explanatory only, and should not be considered to restrict the invention's scope, as described and claimed. Further, features and/or variations may be provided in addition to those set forth herein. For example, embodiments of the invention may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram illustrating an operating environment;

FIG. 2 is an illustration of an example work area;

FIG. 3 is a process diagram illustrating a sequenced invocation;

FIG. 4 is a flow chart of a method for providing dynamic service generation; and

FIG. 5 is a block diagram of a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention.

Embodiments of the present invention may provide for a system and method for providing dynamically triggered application configuration. An agricultural implement, such as a hay baler implement coupled to a tractor, may be automatically configured and monitored before, during, and after operation in a work area. Upon leaving the work area, reports such as an inventory count and location of gathered hay bales may be generated and transmitted to a central system, such as a farm owner's computer-based inventory application. Consistent with embodiments of the invention, invoices for the work performed may be generated according to factors such as time and material efficiency and amount of harvested material gathered and similarly transmitted to the central system.

For example, an independent contractor may be retained to harvest a crop in a given field. The equipment operator may couple an appropriate implement (e.g. a combine harvester) to a tractor. The system may identify the type of implement and retrieve a work order from a central system identifying a field location. A GPS system in the tractor may direct the operator to the field and/or pilot the tractor to the field using an autosteer system. The GPS system may determine when the implement has entered the work area according to a geo-boundary that may be provided with the work order. Upon receiving the work order and/or upon detecting that a trigger associated with entering the work area has occurred, an appropriate application may be transmitted to a computer onboard the tractor, such as a hay baling application operative to inventory the number of bales created, tag the bales' locations in the field for later retrieval, and/or measure the quality, yield, moisture content, etc., associated with each bale. Another trigger may occur upon leaving the work area that may cause the application to finalize the recorded information, transmit a report and/or invoice to the central system.

Dynamic application configuration may be provided to enable the automatic selection of an appropriate farm management information (FMIS) application according to implement and/or tractor type, the location, a time and/or date, information captured by sensors coupled to the implement and/or tractor. The application configuration may identify what work implements are available for coupling to the tractor, what work needs to be done in which fields, which operators are available, and may comprise a priority task list based on factors such as weather forecasts, current market prices, scheduling requirements, etc.

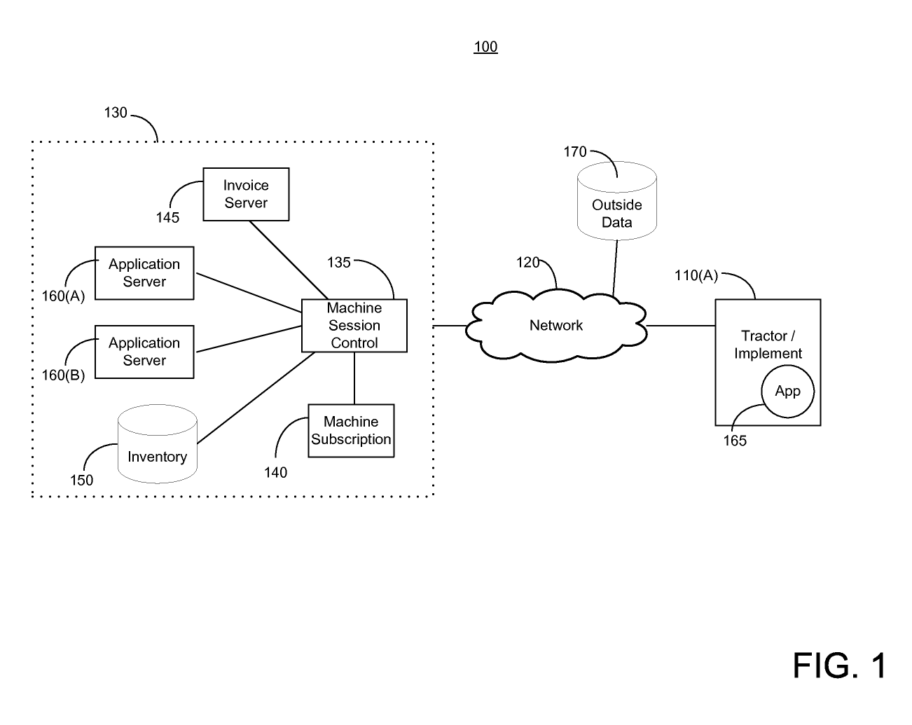

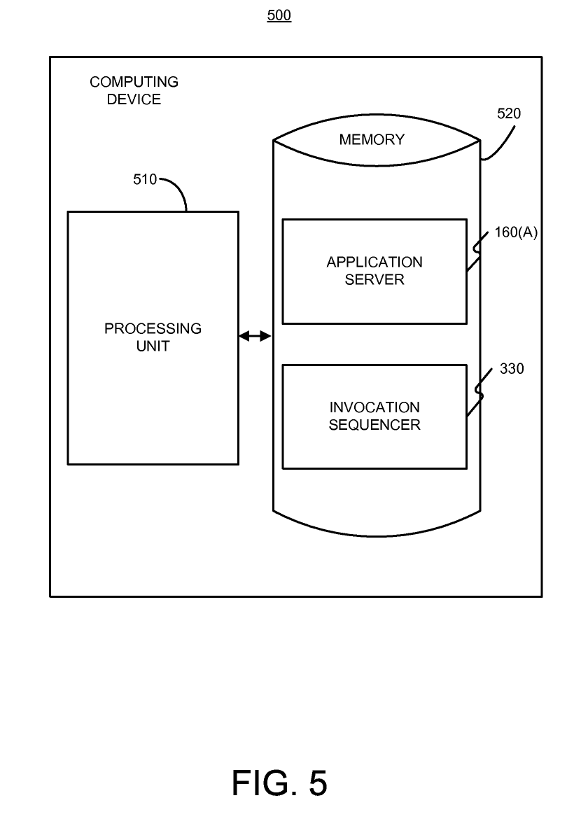

FIG. 1 illustrates an operating environment 100 for providing dynamically triggered application configuration. Operating environment 100 may comprise a tractor/implement 110 coupled via a network 120 to a central system 130. Tractor/implement 110 may comprise a tractor capable of being coupled to a plurality of different work implements (e.g., harvesters, balers, irrigation implements, fertilizing implements, tillers, trailers, crane arms, etc.) and/or a single machine such as a flatbed truck. Network 120 may comprise a communication medium such as a wireless, radio, and/or cellular network. Central system 130 may comprise a plurality of applications that may execute on a computing device 500, described below with respect to FIG. 5, and/or a plurality of different communicatively-coupled computing devices. The applications may comprise a machine session control server 135, a machine subscription server 140, an invoice server 145, an inventory database 150, and/or a plurality of application servers 160(A)-(B). Other elements not shown may also be included in central system 130, such as weather forecasting applications, price tracking applications, yield and/or efficiency reporting applications, and/or operator databases comprising information such as wages and trained skills and proficiencies. Central system 130 may also be operative to communicate with and send and/or retrieve data from an outside data source such as a crop market price and/or weather service.

Central system 130 may be operative to identify whether tractor/implement 110 is associated with an application subscription according to machine subscription server 140 and may download an application 165 to tractor/implement 110 appropriate to a current work assignment. Application 165 may be configured to perform certain functions upon the occurrence of trigger events such as recording a start time and/or initiating data recording when tractor/implement 110 enters a field and/or transmitting a report or invoice when tractor/implement 110 leaves the field.

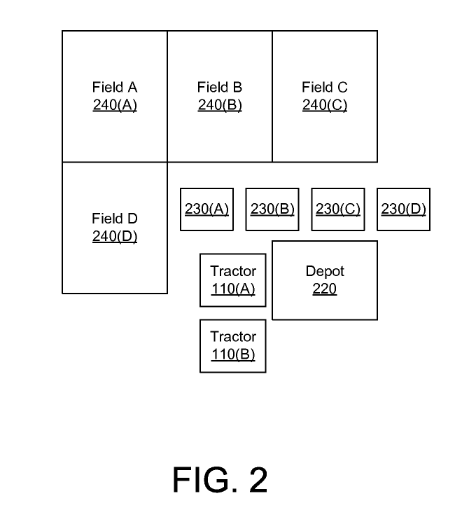

FIG. 2 illustrates an example work area 200. A plurality of tractors 210(A)-(B) may arrive at a depot 220 in the morning. Central system 130 may be located at depot 220 and/or offsite may communicate with tractors 210(A)-(B) via a communication medium such as a wireless, radio, and/or cellular network. The tractor operators may be identified according to skill sets, operation costs (e.g., equipment costs and/or operator wages) and/or tractor capabilities (e.g., tractor 210(A) may comprise a more powerful engine better suited to a heavier work implement than tractor 210(B) and/or tractors 210(A) and/or tractor 210(B) may already have a work implement coupled). The central system may also comprise a list of available work implements such as plurality of implements 230(A)-(D) and/or work areas, such as a plurality of fields 240(A)-(D). For example, work implement 230(A) may comprise a combine harvester, work implement 230(B) may comprise a hay baler, work implement 230(C) may comprise a fertilizer, and work implement 230(D) may comprise a hay bale gatherer. Field 240(A) may comprise a hay field ready for baling, field 240(B) may comprise a hay field that has already been baled but in need of retrieval, field 240(C) may comprise a corn field in need of fertilizing, and field 240(D) may comprise a field in need of tilling.

The central system may provide a work assignment to one and/or more of tractors 210(A)-(B). For example, if tractor 210(A) already has a hay baler implement coupled, tractor 210(A) may be assigned to field 240(A). If tractor 210(B) does not yet have an implement coupled, central system 130 may provide a work assignment according to a work priority list and/or tractor 210(B)'s (and/or its operators) capabilities and/or costs. For example, a weather forecast may provide for rain in the afternoon. Collection of baled hay from field 240(B) may receive a higher priority than fertilization of field 240(C) in order to minimize damage to the quality of the baled hay and/or to avoid excess fertilizer runoff.

Application configurations, triggers, and/or work orders may be downloaded prior to beginning work and/or updated as information is gathered. For example, at the beginning of the work day, a hay baler application (e.g., work application 165) may be downloaded to a tractor/implement 110. if a hay baler application detects that the gathered material is becoming too wet, an updated work order may direct the operator to another work location and/or transmit a location according to the GPS identifying the material for a later attempt. Similarly, if a yield and/or quality measurement determines that the cost of having the operator in a particular location is greater than the value of the crop being harvested, the operator may be directed to increase speed so as to finish the area faster, accepting a lower yield and/or quality in exchange for the operator reaching a higher value area sooner.

Consistent with embodiments of the invention, central system 130 may identify various fields such as fields 240(A)-240(B) and track past work done, current work needed, and/or future work expected. For example, field 240(A) may comprise a plurality of work assignments, their required order, and their status such as: tilled-completed, planted-completed, cut-completed, baled-pending, collected-waiting for baling. The completed assignments may be associated with recorded data such as time spent, costs incurred, yields, quality measurements, etc. As tractor/implement 110 enters boundaries identified for field 240(A), central system 130 may determine whether tractor/implement 110 comprises an appropriate implement for the current work needed in that field. If tractor/implement 110 comprises a hay baler implement and field 240(A) is currently in need of baling, central system 130 may download application 165 as a hay baling application and instruct tractor/implement 110 to begin operation in field 240(A). Application 165 may comprise configuration and/or trigger information such as acceptable moisture content such that if a sensor coupled to tractor/implement 110 detects an unacceptably high moisture level, application 165 may reconfigure for new instructions, such as skipping the wetter areas, tagging their location for later re-attempts, and reporting the problem to central system 130. Other trigger examples may comprise a fuel cost/mileage reporting upon completion of the work (triggered by leaving the field boundary and/or returning to depot 220), providing new instructions to tractor/implement 110 such as directing it to another field to perform similar work or returning to depot 220 to change implements), and/or generating and/or transmitting invoice data to central system 130 associated with the completed work as measured by application 165.

Triggers may comprise automatic start, stop, and/or reconfiguration instructions that may be associated with tractor/implement 110 such as a location, a time/date, a capability, an attached implement, and/or data collected by tractor/implement 110. Triggers may comprise a condition (and/or a plurality of conditions) and an action. For example, a first trigger may comprise the conditions of entering field 240(A) with a hay baler implement attached and an action of initiate hay baler application. A second trigger may become active only after the first trigger has fired, such as one comprising a condition of leaving field 240(A) and an action of reporting gathered data to central system 130.

An example use case may be as follows. Tractor 210(A) may receive a plurality of triggers from central system 130. As tractor 210(A) enters field 240(D) with a hay baling implement attached, triggers may fire associated with field 240(D) to determine whether appropriate work is available for field 240(D). If field 240(D) is currently in need of fertilizing, however, tractor 210(A) has the wrong implement and so no application may be initiated. As tractor 210(A) crosses the boundary into field 240(A), which may be in need of hay baling, a trigger may fire that causes central server 130 to transmit a hay baling application comprising configuration information, data recording instructions, and/or operator instructions to tractor 210(A). The hay baling application may initiate based on the trigger firing and may, for example, provide a suggested route via a GPS display to an operator of tractor 210(A) and/or initiate data recording associated with the working of the hay baling implement.

Other triggers may be operative while the hay baling application is executing. For example, outside data source 170 may provide hay bale prices data to central server 130 enabling a trigger condition based on yield data collected by tractor 210(A). A predicted market value of the hay being baled by tractor 210(A) may be calculated and compared to predicted costs such as operator wages and equipment and fuel costs. If the projected profit is below a configurable threshold, the trigger may fire to stop the application and direct the operator of tractor 210(A) to cease operations in field 240(A). Another trigger may comprise a moisture level threshold that may direct the operator to skip some and/or all of field 240(A) if the moisture content of the hay is too high. The skipped areas may be recorded and transmitted back to central system 130, such as on the firing of another trigger comprising a condition of leaving the boundaries of field 240(A). A single trigger condition, such as leaving the field, may comprise multiple resulting actions, such as requesting new instructions for the operator and transmitting inventory and collection data to central system 130. For example, the hay baling application may transmit data comprising a GPS location for each bale ready for pickup and may comprise additional data such as warnings about which bales may comprise a higher moisture content than desired and so may require special handling.

Agricultural technology domain areas (ATDA) may comprise features and functionality used by a farmer to provide management, logistics, planning and operational efficiencies in the application and harvesting of material. A farmer may have access to many machines and implements that may comprise different makes, models, and have different configurations that generate unstructured process data. Consistent with embodiments of the invention, an architecture layer, referred to herein as an Agricultural Application Control Subsystem (AACS), may be provided allowing user and/or location based customization and configuration independent of the underlying machine specific implementations. Applications may be designed for use with multiple makes and models by relying on the architecture layer to translate abstracted instructions (e.g., “collect moisture level data”) into specific control instructions for a given implement.

Tractor 110 may provide data through a standardized interface, such as that described by ISO 11783 over network 120 to central system 130, which may then store and/or convert the data into a standard format (e.g., XML) and/or a proprietary format associated with a particular data management application. The converted data may be made available to a farmer through an interface application, such as on a personal computer and may be used by value-added service applications, such as profit and loss analysis applications. Further, data from different machines may be collected, converted into a common format, and aggregated for use in a single analysis application. A closed loop architecture comprising a machine and a server in communication may be used. Process data may be sent to the server, analyzed, and adjustments may be made to the machine's configuration.

The AACS may comprise a three-layer architecture structure. A first layer may comprise a transport plane comprising physical resources necessary for a connection from the agricultural machine to a middle layer. The middle layer may comprise a control plane that may comprise intelligent elements that may determine whether a data from a tractor is allowed to enter the network and which ATDA(s) to invoke in a top layer. The top layer may comprise an application plane where the ATDA(s) reside. The lower layer may be represented, for example, as a combination of a cellular network and a mobile application system, the AACS, and a network application system.

The AACS may be responsible for examining each process-data record as it enters central system 130. This examination may be implemented, for example, via machine session control server 135 and/or machine subscription server 140. AACS may provide session control by recognizing that a machine may be generating process-data and that it may be possible to provide additional features and functionalities to the machine or to the ATDA service provider's application. A session may comprise a path of the data to ATDA service provider(s) from the machine and visa versa. Session control may allows establishment of a session and/or two-way transmission between central server 130 and tractor 110 during the life time of that session. An example of a service may comprise the storage of process data, such as in inventory database 150. Once the machine starts sending data, a session may be started by creating a path between the machine data and the storage service. If the data includes GPS coordinates it may be possible during the session life time to engage another service such as a geofence analysis.

A geofence may comprise a virtual perimeter for a real-world geographic area. When a location-aware device of a location-based service (LBS) user enters or exits a geofence, the device receives a generated notification. This notification might contain information about the location of the device. Geofencing is an element associated with telematics hardware and software. It may allow users of the system to draw zones around places of work, customers sites, fields, and/or secure areas. These geofences, when crossed by an equipped vehicle or person may trigger a notification to the user or operator.

Through session control, the AACS may allow the determination of routing information (address) for a machine (e.g. for sending updated information, content adaptation for incompatible devices (e.g. converting units of captured data to the ISO 11783 standard), and interworking between different access networks. Session control may further enable the provision of application logic not natively available in devices (e.g. data corrections and auto field detection algorithms or the addition of coding data like an operator's name) and supplemental outside information for the application (e.g. weather information or commodity pricing). Session control may also provide store and forward capabilities when one ATDA service provider is not connected (e.g. the user of a FMIS software package is not at the computer) or when a machine is not in coverage. Session control may also offer authentication and authorization functionality.

The AACS architecture may provide two mechanisms with which to blend applications already deployed in the network to create new ATDA services—Initial Filter Criteria (IFC) and service brokering. The iFC may comprise a set of prioritized trigger points assigned to a subscriber's profile that indicate the order in which multiple application servers (e.g., application servers 160(A)-(B)) may be invoked depending on what services a user has subscribed to.

IFC implementation may use triggers that may define a set of conditions under which a particular application server is notified about the existence of data. Particular conditions may be provided in the form of regular expressions. IFCs may define a correlation between a set of triggers and particular application server(s) responsible for execution of the associated service logic. The process data flow through the AACS may begin with the machine (e.g., tractor 110) capturing data and sending it to session control server 135 of central system 130. The process data from the machine may be parsed and a machine ID may be captured. The machine ID may be sent to machine subscriber server 140 to determine if the machine is allowed to enter this server (e.g. authentication and/or determination of whether the machine is an active paid subscriber). The applications that the machine has subscribed to may be returned to session control server 135 in the form of application profiles. Session control server 135 may examine each telemetry message against the IFC contained in the application profile(s); if a match occurs, the session may be assigned to an Application Server. The IFC may be able to select an application server based on the process data. That is, central server 130 may dynamically assign each session to a service. For example, if the process data does not include the speed of the machine but does include GPS, then a session may be dynamically assigned to a speed-as-a-function-of-GPS data service.

The service brokerage may comprise a set of rules that govern service invocation during the life time of a session. The application profile may assign a quality of service (QoS, e.g., a required speed or performance of the network) value to force a route used by the assigned application server to allow real time access to the data.

Application services may be offered as packages and/or individual applications that may incur a one-time, a periodic, and/or a recurring cost. A flexible charging mechanism may allow a network operator to offer a differential value beyond just set pricing or monthly fees. Pricing scenarios may be supported in the ACSS such as prepaid, postpaid, machine owner pays, ATDA service provider pays, and/or data storage costs (e.g., pay per data increment consumed and/or made available). Application services may comprise, for example, data analysis applications, external data provider applications, auto field detections algorithms, data shaping algorithms, mapping services, invoicing services, geofencing services, SMS services, e-mail services, streaming audio and/or video, and/or firmware and/or software application upgrade services. Each session may be associated with a set of services invoked as desired by the end user and/or the ATDA service provider. A list of services invoked, the time, date and length of invocation may be captured in a Charging Data Record (CDR). The CDR is then used by a billing entity against a rate sheet to create a bill.

The following use case is provided as a non-limiting example of embodiments of the invention. A farmer may create a new application called “Baler Inventory and Invoice.” Central system 130 may request the farmer to configure the application by providing details such as a location, desired equipment and/or operators, and/or scheduling data. The farmer may configure the application for use in field 240(A) when he is using tractor 110(A) with implement 230(A). The farmer may use two triggers such as geofence and machine configuration. He may assign the field name to the geofence trigger and the machine configuration to a machine and implement triggers.

The Initial Filter Criteria may be created to define when and where to start the application. In addition, the application may also know when to stop. Two filters may be created as shown below. A session may be started once the condition(s) of Example Trigger 1 are met and the session may remain active until an end condition such as Example Trigger 2 is satisfied.

Example Trigger 1
If GeoFence == field 240(A) &&
If Machine == tractor 110(A) &&
If Implement == implement 230(A) &&
Then Start the Baler Inventory and Invoicing Application

Example Trigger 2
If Application == implement 230(A) &&
If Application == Started &&
GeoFence != field 240(A) ∥
If Machine != tractor 110 ∥
If Implement != implement 230(A) ∥
Then Stop the Baler Inventory and Invoicing Application

The application provisioning process may store the IFC as part of the farmer's application profile for that machine into machine subscription server 140. The ACSS may continuously monitor process data from all machines. Machine process data may be sent to an application control function and its data may be parsed and sent to machine subscription server 140. Machine subscription server 140 may find the application profile and return the IFCs. Until the triggers for the Baler is met, the data may be stored via a default process. Each time a set of process data is sent to the ACF, it may be parsed and examined to perform machine authentication, load in the application service profile, and executes the IFCs. For example, the geofences service may be invoked to determine whether the machine is in the trigger field.

If the process data matches the IFC, a session (a stateful program counter that assist in application control) may be created and a Session Detailed Record (SDR) for billing purposes may be generated. A message may be sent to one of application servers 160(A)-(B), such as applications server 160(A), comprising the SDR and an instruction to start the baler application. Application server 160(A) may receive the message, parse the SDR, and begins work. Application server 160(A) may download the baler application and/or a task to a task controller on tractor 110(A) so that the machine may capture the correct data. For example, the baler application may be transmitted to tractor 110 as application 165. Application 165 may begin to query the machine process data. The process data may allow application 165 to count the number of bales and record the location of the bales. Session control server 135 may monitor the machine process data until the IFC that ends the application is met. An SDR associated with stopping the application may be sent to application server 160(A), the application may be stopped, and the SDRs may be logged to be retrieved by a billing system such as invoice server 145.

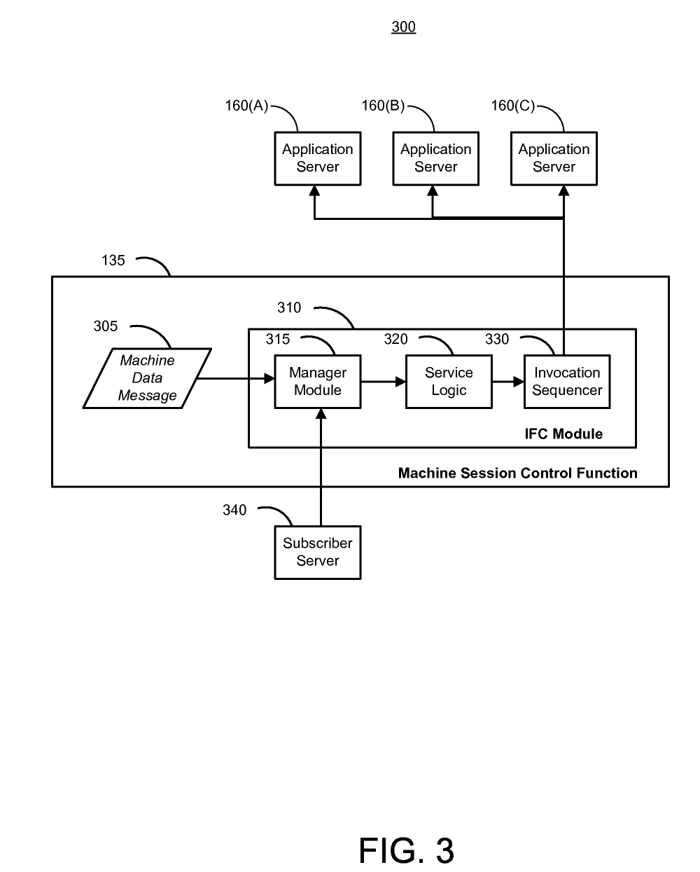

FIG. 3 is process diagram 300 illustrating an invocation sequence. Process diagram 300 may comprise an incoming machine data message 310, such as may be received at machine session control 135 from tractor/implement 110(A) over network 120. Machine data message 305 may be passed to an Initial Filter Criteria (IFC) module 310 for evaluation. IFC module 310 may be passed to a manager module 315 to match a machine ID associated with machine data message 305 with a service subscription. Manager module 315 may pass the data to a service logic unit 320 that may be operative to select an appropriate subscription entry for the data. For example, service logic unit 320 may determine that machine data message 305 is associated with a hay baler machine and thus recognize that a hay baler subscription entry is more appropriate than an irrigation entry.

Service logic unit 320 may also be operative to receive selections of desired services from a subscription contact. The list of services may be passed to an invocation sequencer 330 operative to determine whether any of the selected services rely on any others to operate on received data first. For example, an owner may institute a merit reward system for machine operators that stay under a speed limit. Two application services may be needed, a speed analyzer service and a reward payout service. The speed analyzer service may need to calculate whether the operator exceeded the speed limit before the reward payout service is authorized to pay the merit reward to the operator. When machine data message 305 is received comprising the necessary speed information, invocation sequencer may invoke the speed analyzer application service on the data prior to invoking the reward payout application service. Consistent with embodiments of the invention, the earlier invoked application service may specify whether the later service still needs to be called on the data. For example, the speed analyzer module may determine that machine data message 305 comprises corrupted data that cannot be analyzed, so no reward payout (or other derivative use of the data) should be calculated.

Service logic 320 may be operative to determine whether another available application service can recover from such a corrupted data error. For example, even if speedometer data may be corrupt, if machine data message 305 comprises Global Positioning System (GPS) data then another application service may be able to calculate a speed from that. Is application service 160(A) is unable to calculate the max speed from machine data message 305, application service 160(B) may be able to do some from time/date stamped GPS coordinates. The alternately calculated speed may then be passed to a reward payout module, such as application service 160(C) for evaluation.

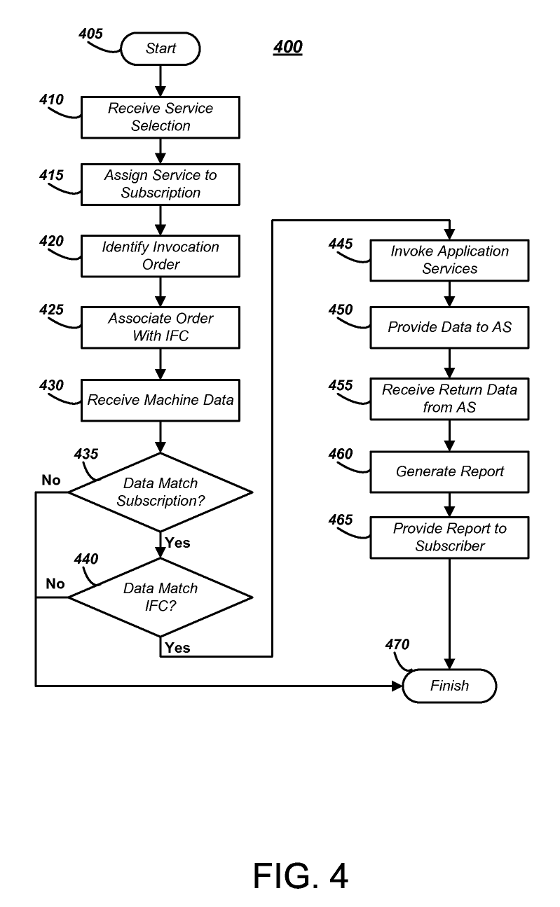

FIG. 4 is a flow chart setting forth the general stages involved in a method 400 consistent with an embodiment of the invention for providing agricultural inventorying and invoicing. Method 400 may be implemented using computing device 500 as described in more detail above with respect to FIG. 5. Ways to implement the stages of method 400 will be described in greater detail below. Method 400 may begin at starting block 405 and proceed to stage 410 where computing device 500 may receive a service selection. For example, an owner of a machine may select a plurality of application services 160(A)-(C) that may operate on and/or analyze data provided by an identified machine.

From stage 410, method 400 may advance to stage 415 where computing device 500 may assign the selected service(s) to a subscription. For example, the owner may be associated with a monthly service subscription and/or a per-use access charge subscription. The subscription may identify a plurality of machines and/or implements that may access different application services.

From stage 415, method 400 may advance to stage 420 where computing device 500 may identify an invocation order for the selected services. For example, the owner may select a speed evaluation service and a merit reward payout service. Invocation sequencer 330 may determine that the speed evaluation service may need to operate on the data before the data may be provided to the merit reward payout service.

From stage 420, method 400 may advance to stage 425 where computing device 500 may associate the invocation order with an initial filter criteria. For example, the selected services may be associated with an IFC trigger condition associated with a particular machine or implement type, a work area, and/or a particular operator.

From stage 425, method 400 may advance to stage 430 where computing device 500 may receive a data transmission from the machine. For example, data (such as a harvested quantity of agricultural material) gathered by tractor/implement 110(A) may be transferred to central system 130. The transfer may comprise, for example, a mechanism such as a portable data storage device (e.g., a flash drive) and/or a wireless or wireline data transfer, such as over network 120.

From stage 430, method 400 may advance to stage 435 where computing device 500 may determine whether the machine providing the data is associated with an active subscription. For example, the data transfer may comprise a machine identifier associated with an owner and/or operator of the machine. A database may comprise a plurality of subscription entries associated with machine identifiers allowing computing device 500 to look up any entries comprising the received machine identifier. If not, method 400 may end at stage 470.

Otherwise, method 400 may advance to stage 440 where computing device 500 may determine whether an initial filter criteria (IFC) matches the data. For example, the data may comprise a hay bale harvest report associated with field 240(A) with a moisture content measurement. The IFC may comprise a trigger condition requiring data from field 240(A) from that machine to evaluate and report on average moisture content. If no IFC condition is associated with the data, method 400 may end at stage 470.

Otherwise, from stage 440, method 400 may advance to stage 445 where computing device 500 may invoke the application services associated with the IFC. For example, invocation sequencer may invoke application services 160(A)-(C) in the identified order.

Method 400 may then advance to stage 450 where computing device 500 may send the data to each application service in turn. For example, central system 130 may transfer the data to application service 160(A) for analysis.

Method 400 may then advance to stage 455 where computing device 500 may receive return data from the application service. For example, application service 160(A) may analyze the data, such as by performing calculations or transformations on the data and/or combining the received data with other data. One example may comprise receiving a harvested amount data from a harvesting machine and combining that data with a current market price of the crop to calculate a profit. Computing device 500 may then send the data, with and/or without modifications from application service 160(A), to the next application service in the sequence.

Method 400 may then advance to stage 460 where computing device 500 may generate a report. For example, central server 130 may prepare a report detailing an analysis of the data from application services 160(A)-(B). This report may then be provided to the operator and/or owner of the machine at stage 465, such as via e-mail, a web page, a text message, and/or as a hardcopy print out. Method 400 may then end at stage 470.

FIG. 5 illustrates a computing device 500 as configured to operate as central system 130. Computing device 500 may include a processing unit 510 and a memory unit 520. Memory 520 may comprise, for example, application server 160(A) and invocation sequencer 330. While executing on processing unit 310, application server 160(A) and/or invocation sequencer 330 may perform processes for providing embodiments of the invention as described above.

Computing device 500 may be implemented using a personal computer, a network computer, a server, a mainframe, or other similar microcomputer-based workstation. The processor may comprise any computer operating environment, such as hand-held devices, multiprocessor systems, microprocessor-based or programmable sender electronic devices, minicomputers, mainframe computers, and the like. The processor may also be practiced in distributed computing environments where tasks are performed by remote processing devices. Furthermore, the processor may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, a wireless fidelity (Wi-Fi) access point, or a facsimile machine. The aforementioned systems and devices are examples and the processor may comprise other systems or devices.

An embodiment consistent with the invention may comprise a system for providing application service generation. The system may comprise a memory storage and a processing unit coupled to the memory storage. The processing unit may be operative to create an application service, receive a data transmission from a machine, wherein the data transmission comprises a machine identifier, identify an application service associated with the machine according to the machine identifier, such as by determining whether the machine identifier is authorized to access the application service, invoke the application service on the transmitted data, and receive a response message from the application service. Creating the application service may comprise, for example, selecting a data analysis capability, creating an initial filter criteria trigger, selecting a data measurement requirement, and identifying a prerequisite service.

The processing unit may be further operative to determine whether the application service associated with the machine comprises a prerequisite service and, if so, invoke the prerequisite service on the transmitted data, receive a modification to the transmitted data from the prerequisite service, and invoke the application service on the modified data. The modification to the transmitted data may comprise, for example, associating the transmitted data with at least one second plurality of data and/or a calculation to be performed on the transmitted data. For example, the transmitted data may comprise harvest yield data that may be combined with current market price data from which an expected profit may be calculated. The processing unit may be further operative to determine whether the transmitted data does not comprise an essential data element associated with the application service and, if the essential data element is missing, determine whether the essential data element is available from another source, such as by determining whether a second application service is operative to calculate the essential data element from the transmitted data and/or a second data transmission.

Another embodiment consistent with the invention may comprise a system for providing application service generation. The system may comprise a memory storage and a processing unit coupled to the memory storage. The processing unit may be operative to receive a transmission from an agricultural machine, wherein the transmission comprises at least one data measurement and an identifier associated with the agricultural machine, determine whether the identifier is associated with a service subscription, and in response to determining that the identifier is associated with the service subscription, invoke a plurality of instances, each associated with an application service, according to an invocation order associated with the service subscription, and provide the data measurement to each of the plurality of application services for analysis. The processing unit may be further operative to receive a selection of the plurality of application services from an owner of the agricultural machine and/or establish the invocation order according to a pre-requisite data analysis to be performed by at least one of the plurality of application services. Analysis of the data measurement by at least one first application service may comprise, for example, the processing unit being operative to determine whether an operator of the agricultural machine exceeded a speed limit and/or whether to credit a merit award to an operator of the agricultural machine.

The processing unit may be further operative to determine whether the at least one first application service was unable to determine whether the operator of the agricultural machine exceeded the speed limit due to at least one of the following: a corruption of the at least one data measurement and a non-receipt of a required second data measurement. In response to determining that the at least one first application service was unable to determine whether the operator of the agricultural machine exceeded the speed limit, the processing unit may be operative to provide the at least one data measurement to at least one third application service operative to estimate a speed of the agricultural machine according to the at least one data measurement. For example, the data measurement may comprise time/date stamped GPS data measurements from which a speed may be calculated.

Yet another embodiment consistent with the invention may comprise a system for providing an application service generation. The system may comprise a memory storage and a processing unit coupled to the memory storage. The processing unit may be operative to receive a selection a plurality of application services, associate the plurality of application services with a subscription, create an invocation order for the plurality of application services, receive a data measurement from a machine associated with the subscription, provide the data measurement to the plurality of application services according to the invocation order, receive a modification to the data measurement from at least one of the plurality of application services, produce a report comprising the modification to the data measurement, and provide the report to a contact associated with the subscription. The report may be provided to the contact via, for example, a web page, an e-mail, a printed report, and/or a text message. The invocation order may be stored in one of a plurality of IFCs that may comprise differing invocation orders. Each IFC may comprises a trigger condition to be compared to the received data measurement in order to determine which invocation order is to be applied.

While certain embodiments of the invention have been described, other embodiments may exist. While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

We claim:

1. A method for providing application service generation, the method comprising:
creating an application service;
receiving a data transmission from a machine, wherein the data transmission comprises a machine identifier;
identifying an application service associated with the machine according to the machine identifier;
invoking the application service on the transmitted data; and
receiving a response message from the application service.

2. The method of claim 1, wherein creating the application service comprises at least one of the following: selecting a data analysis capability, creating an initial filter criteria trigger, selecting a data measurement requirement, and identifying a prerequisite service.

3. The method of claim 1, further comprising:
determining whether the application service associated with the machine comprises a prerequisite service; and
in response to determining that the application service comprises the prerequisite service:
invoking the prerequisite service on the transmitted data,
receiving a modification to the transmitted data from the prerequisite service, and
invoking the application service on the modified data.

4. The method of claim 3, wherein the modification to the transmitted data comprises associating the transmitted data with at least one second plurality of data.

5. The method of claim 3, wherein the modification to the transmitted data comprises a calculation to be performed on the transmitted data.

6. The method of claim 1, wherein identifying an application service associated with the machine according to the machine identifier comprises determining whether the machine identifier is authorized to access the application service.

7. The method of claim 1, further comprising:
determining whether the transmitted data does not comprise an essential data element associated with the application service; and
in response to determining that the transmitted data does not comprise the essential data element associated with the application service, determining whether the essential data element is available from another source.

8. The method of claim 7, wherein determining whether the essential data element is available from another source comprises determining whether a second application service is operative to calculate the essential data element from the transmitted data.

9. The method of claim 7, wherein determining whether the essential data element is available from another source comprises determining whether a second application service is operative to calculate the essential data element from a second data transmission from the machine.

10. A system for responding to a service request, the system comprising:
a memory storage; and
a processing unit coupled to the memory storage, wherein the processing unit is operative to:
receive a transmission from an agricultural machine, wherein the transmission comprises at least one data measurement and an identifier associated with the agricultural machine,
determine whether the identifier is associated with a service subscription, and
in response to determining that the identifier is associated with the service subscription:
invoke a plurality of instances, each associated with an application service, according to an invocation order associated with the service subscription, and
provide the data measurement to each of the plurality of application services for analysis.

11. The system of claim 10, wherein the processing unit is further operative to receive a selection of the plurality of application services from an owner of the agricultural machine.

12. The system of claim 10, wherein the processing unit is further operative to establish the invocation order according to a pre-requisite data analysis to be performed by at least one of the plurality of application services.

13. The system of claim 12, wherein the analysis of the data measurement by at least one first application service comprises the processing unit being operative to determine whether an operator of the agricultural machine exceeded a speed limit.

14. The system of claim 13, wherein determining whether the operator of the agricultural machine exceeded the speed limit comprises the pre-requisite data analysis for at least one second application service, and wherein the at least one second application service comprises the processing unit being operative to determine whether to credit a merit award to an operator of the agricultural machine.

15. The system of claim 12, wherein the processing unit is further operative to:
determine whether the at least one first application service was unable to determine whether the operator of the agricultural machine exceeded the speed limit due to at least one of the following: a corruption of the at least one data measurement and a non-receipt of a required second data measurement; and
in response to determining that the at least one first application service was unable to determine whether the operator of the agricultural machine exceeded the speed limit, providing the at least one data measurement to at least one third application service.

16. The system of claim 15, wherein the at least one third application service comprises the processing unit being operative to estimate a speed of the agricultural machine according to the at least one data measurement wherein the at least one data measurement comprises a global positioning system data measurement.

17. A computer-readable medium which stores a set of instructions which when executed performs a method for providing application service generation, the method executed by the set of instructions comprising:
receiving a selection a plurality of application services;
associating the plurality of application services with a subscription;
creating an invocation order for the plurality of application services;
receiving a data measurement from a machine associated with the subscription;
providing the data measurement to the plurality of application services according to the invocation order;
receiving a modification to the data measurement from at least one of the plurality of application services;
producing a report comprising the modification to the data measurement; and
providing the report to a contact associated with the subscription.

18. The computer-readable medium of claim 17, wherein the report is provided to the contact via at least one of the following: a web page, an e-mail, a printed report, and a text message.

19. The computer-readable medium of claim 17, wherein the invocation order is stored in an initial filter criteria (IFC).

20. The computer-readable medium of claim 19, wherein a plurality of IFCs each comprise a different invocation order and wherein the IFC further comprises a trigger condition to be compared to the received data measurement.
